(19) United States
(12) Patent Application Publication
(10) Pub. No.: US 2019/0174599 A1
(43) Pub. Date: Jun. 6, 2019

(54) LIGHT CONTROL DEVICE AS INTERNET HUB

(71) Applicant: Javier Senas, Regensburg (DE)

(72) Inventor: Javier Senas, Regensburg (DE)

(21) Appl. No.: 15/990,802

(22) Filed: May 28, 2018

(30) Foreign Application Priority Data
Dec. 4, 2017 (DE) 2017 128 703.5

(51) Int. Cl. H05B 33/08; H05B 37/02

(52) U.S. Cl. CPC H05B 33/0863; H05B 37/0272

(57) ABSTRACT

The invention relates to a light control device associated with a light source, that includes a communication module configured to enable a communication between the light control device and another device different to a given communication network.

### CROSS-REFERENCE TO RELATED APPLICATIONS

The present application claims priority to German patent application number 10 2017 128 703.5, entitled, LIGHT CONTROL DEVICE, filed in the German Patent Office on Dec. 4, 2017. The entirety of that application is fully incorporated by reference herein.

### FIELD OF INVENTION

The invention relates to a light control device, wherein light control device is associated with a light source.

### BACKGROUND

Internet of Things (IoT) is the network of interconnected things/devices Which are embedded with sensors, so care, network connectivity and required electronics that enables them to collect and exchange data making them responsive. IoT is essentially an architectural framework, which allows integration and data exchange between the physical world and computer systems over existing network infrastructure.

IoT works well with battery but it has no Internet access. Therefore, there is a need for an additional Internet bridge. The current solutions to provide Internet access to such battery-operated devices comprise an additional and external device called gateway which is connected to a plug and it must be present in the room where the Bluetooth device is to assure proper coverage and therefore connection. Accordingly, a need still exists for improvement in accessibility.

### SUMMARY

The object of the invention is to contribute to a better accessibility of IoT devices.

The invention is distinguished by a light control device that is associated with a light source. Light control device includes a communication module configured to enable communication between light control device and other devices that are different than light control device to a given communication network.

### BRIEF DESCRIPTION OF THE DRAWINGS

The invention can be better understood by referring to the following Figures. The components in the Figures are not necessarily to scale, emphasis instead being, placed upon illustrating the principles of the invention.

FIG. 1 illustrates the light control device integrated into a wall light switch.

FIG. 2 illustrates the light control device integrated into a light source.

FIG. 3 illustrates the light control device integrated into a lamp.

FIG. 4 illustrates the light control device integrated into a light panel.

### DETAILED DESCRIPTION

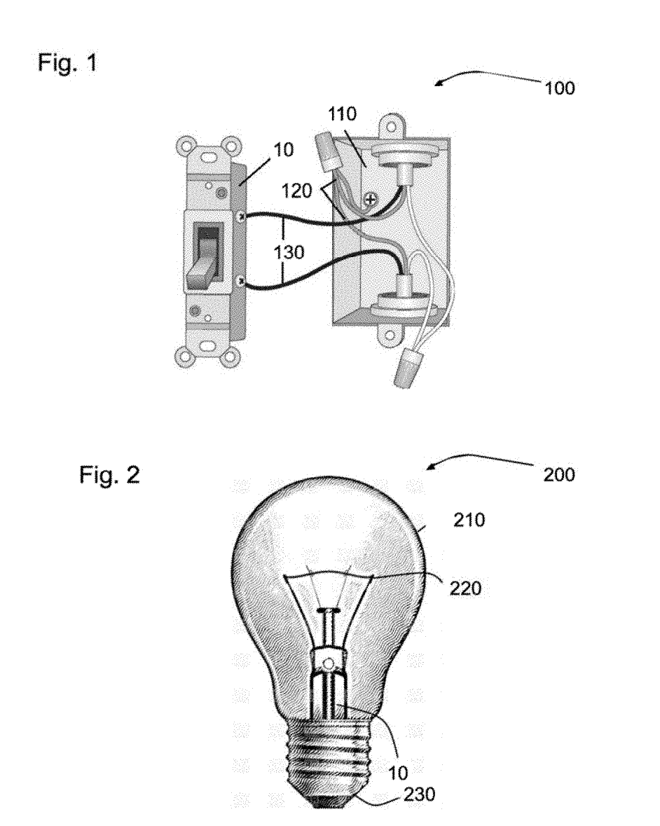

With reference to the various Figures, FIG. 1 shows a light control device 10 integrated into a wall light switch 100. Wall light switch 100 comprises a first housing no which is normally integrated into a wall. Wall light switch 100 further comprises at least one ground wire 120 and one power wire 130 for electrical supply of light control device 10 and for the function of wall light switch 100 as a switch for at least one light source. The potential place of light control device 10 in wall light switch 10 is not limited to the shown place.

Light control device 10 is associated with at least one a light source and comprises a communication module, wherein the communication module is configured to enable a communication between light control device and other device different than such light control device to a given communication network. The electrical device other than light source is, for example, an IoT device which requires an external hub, gateway, bridge or controller to have access to the Internet. Since in almost every room in a house there is at least one light source, or as light sources may be across the street, light control device which is associated with a light source can be used for various IoT devices to have access to a given communication network, as for example to the Internet. As such, additional plugs are avoided, which lowers costs.

By enabling a communication between the electrical device and the given communication network, light control device acts as a hub, gateway, bridge or controller to provide access to the communication network. The communication module comprises for example at least two communication interfaces, one for a communication with a router or access point and another one for a communication with the electrical device and/or the communication interface acts itself as a router or access point.

The communication network is, for example and in specific embodiments of the invention, a WLAN and/or the internet.

The communication module is configured to communicate with the electrical device, for example, by using a communication based on. Bluetooth, BLE, Zigbee, Z-Wave, WiFi, LiFi, LoRa, Sigfox, Weightless-P, NB-IoT, cellular and/or any other fireless technology.

In specific embodiments of the invention, light control device 10 further comprises a light control module wherein light control module is configured to control light source and/or a further light source (e.g. turning them on, off and/or varying the intensity) based on a message received by the communication module via the communication network

Thus, the above described light control device 10 can be used as a hub, gateway, bridge or controller to provide access to the Internet to all electrical devices which are in its wireless range in order to harmonize their control. Furthermore, light control device 10 can be the interface to provide remote access, control, monitoring and/or notifications from any place in the world.

Light control device 10 may, in specific embodiments of the invention, also be programmed to track activity of such lights by power consumption monitoring.

Light control device 10 may, in specific embodiments of the invention, further be adapted to permit a user to command and control the electrical device, to integrate information into a data management application, and/or to store data. Advantageously, light control device to can thus store data relevant, for example in the Internet from the electrical device which itself is not able to store such data.

Light control device 10 may also be programmed to analyze or integrate stored data, and to provide a user interface for accessing this data. In specific embodiments of the invention, this user interface can be a graphical user interface.

Light control device 10 may further be programmed to track activity of the connected electrical device and/or to notify if an alarm condition is generated by or associated with the connected electrical device and/or to monitor variables associated with the performance of the electrical device and/or to associate events with time.

Light control device 10 may, in specific embodiments of the invention, be connected to the Internet or cloud to, such as and not limited to WiFi, LiFi, cellular network (2G, 3G, 4G or 5G) or IoT technologies such as NB-IoT, LoRa, Sigfox or Weightless-P. Thus, light control device 10 can be the Internet access point to other electrical devices which cannot have direct access to the Internet by themselves, for example, since they are using technologies such as and not limited to, Bluetooth, BLE (Bluetooth Low Energy), Zigbee, z-wave, Infrared or any other wireless technology.

In alternative embodiments of the invention, light control device 10 is connected to the Internet or cloud to at least one of WiFi, LiFi, cellular network (2G, 3G, 4G or 5G) or IoT technologies such as NB-IoT, LoRa, Sigfox or Weightless-P and acts as a hub of electrical devices, which are using the same or similar technologies with the goal of harmonizing all electrical devices within the same Graphical User Interface, the same software, same place for local control and/or same speaker for voice commands,

The electrical device connected to light control device 10 may, in certain various embodiments, comprise an individual heating radiator controller or a thermostat providing remote heating turning on/off and/or turning on/off notifications to a user via the communication network, an electrical door lock providing remote opening/closing control and/or opening/closing notifications to a user via the communication network, water and/or gas meter(s) providing remote control, notifications and data storage to a user via the communication network, water sprinkler(s) providing remote opening/closing water valve and/or opening/closing notifications to a user via the communication network, smoke detector(s) and/or security/camera/surveillance system(s) providing remote notifications to a user via the communication network, household appliances such as but not limited to Washing or. Drying Machine to provide remote control and notifications to a user via the communication network, blinds and/or shades motors providing local rolling down/up to them just by interacting with light control device 10 itself by using different buttons, gestures or sliders or via the communication network, garage door motor providing local opening/closing by interacting with light control device 10 itself by using different buttons, gestures or sliders or via the communication network, porch marquise motor(s) providing local opening/closing with light control device 10 itself by using different buttons, gestures or sliders or via the communication network, sensors integrated in a parking spot and/or traffic signal to provide remote control and notifications to a user via the communication network, and/or sensors in a rubbish bin to provide remote control and notifications to a user via the communication network.

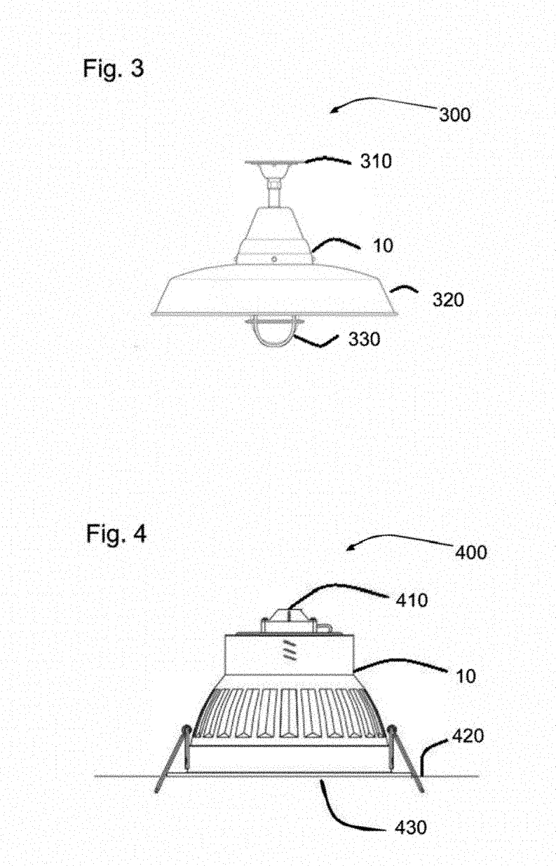

Light control device 10 can also be integrated into other parts associated with light source. For example, and in the specific embodiment of the invention illustrated in FIG. 2, light control device 10 is integrated into a light source 200,

Light source 200 comprises a housing 210, a light emitting source 220, and a connection to an electrical power 230. The potential place of light control device 10 in light source 200 is not limited to the shown place.

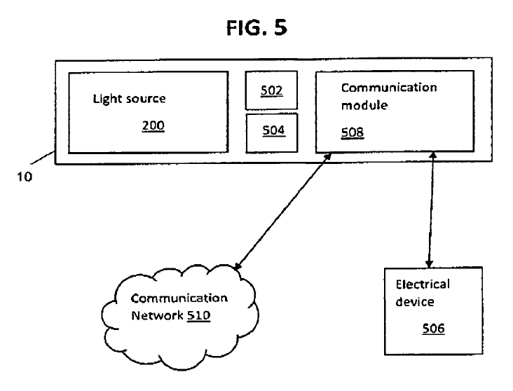

For example, and in the specific embodiment of the invention illustrated in FIG. 3, light control device 10 is integrated into a lamp 300. Lamp 300 comprises a connection to an electrical power 310, a housing 320, and a light emitting source 330. The potential place of light control device 10 in lamp 300 is not limited to the shown place.

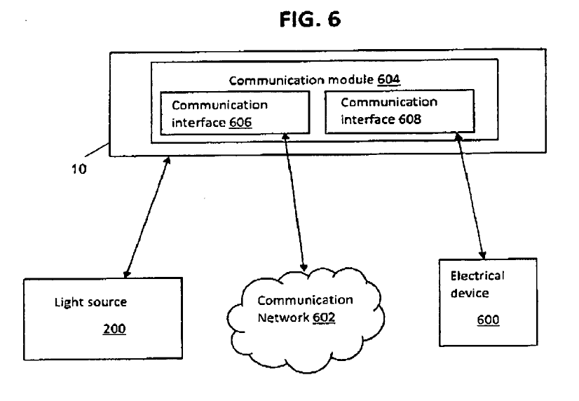

For example, and in the embodiment of the invention illustrated in FIG. 4, light control device 10 may be integrated into a light panel 400.

Light panel 400 comprises a connection to an electrical power 410 and a light emitting source 430, and is positioned on a wall, ceiling or floor 420. The potential place of light control device 10 in light panel 400 is not limited to the shown place.

If light control device 10 is arranged inside a bulb, fixture and/or panel, it is possible to avoid a light switch in a wall and use a mobile light switch since light control device 10 can be directly connected with the electrical power wires of light source to control light source. As used herein, a light fixture includes any device that emits light, including but not limited to a lamp, light panel, device comprising a bulb, light switch, or the like.

According to one embodiment, the communication network is WLAN, WiFi and/or LiFi.

According to a further embodiment, the communication network is cellular (2G, 3G, 4G and/or 5G), NB-IoT, LoRa, Sigfox, Weightless-P and/or any other similar wireless technology.

According to a further embodiment, the communication module is configured to communicate with the electrical device by using a communication based on Bluetooth, BLE, Zigbee, Z-Wave, LP6Wan and/or any other similar wireless technology.

Bluetooth is a wireless technology standard for exchanging data over short distances. Bluetooth is managed by the Bluetooth Special Interest Group (SIG). Zigbee is an IEEE 802.15.4-based specification. Z-Wave is a wireless communications protocol Developed by Zensys. Wi-Fi or WiFi is a technology for wireless local area networking with devices based on the IEEE 802.11 standard. Like Wi-Fi, Li-Fi is wireless and uses similar 802.11 protocols; but it uses Ultraviolet, Infrared and visible light communication. LoRa is a proprietary, chirp spread spectrum (CSS) radio modulation technology for LPWAN (Low-Power Wide-Area Network), Sigfox employs a proprietary technology that enables communication using the Industrial, Scientific and Medical ISM radio band which uses 868 MHz in Europe and 902 MHz in the US. Weightless-P is a LPWAN open wireless technology standard. Narrow Band IoT (NB-IoT is a Low Power Wide Area Network (LPWAN) radio technology standard. RFID is Radio Frequency Identification whose tags contain electronically-stored information.

Many of the above-mentioned communication methods have a short range. Thus, since in almost every room in a house is at least one light source. The light control device can act as a communication interface allowing access to electrical devices, which use one of the communication methods of the communication network.

According to a further embodiment, light control device 10 further comprises a light control module configured to control light source 200 and/or a further light source based on a message received by the communication module via the communication network.

According to a further embodiment, light control device 10 further comprises at least one microphone and/or speaker and is constructed to understand voice commands and/or be able to reply and/or be able to play music. With such voice commands, lights and/or other electrical device could be able, but not limited to, change status, select timer and/or send information.

According to a further embodiment, light control device 10 is adapted to act as a repeater to broadcast the signal from such light control device to another to increase transmission and/or reception range of the given communication network.

In accordance with the invention, a novel light fixture is claimed and described. The various embodiments of the light fixtures integrate the described and claimed light control devices of the invention. Light control device is integrated into a light fixture, more specifically, at least one of a wall light switch, light source, or a light fixture or lamp.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents,

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

1. A light control device associated with a light source, said light control device comprising:
a housing; and
a communication module configured to enable communication for an electrical device over a first communication network,
wherein said communication module is housed in said housing,
wherein said communication module includes a first communication interface and a second communication interface,
wherein said electrical device communicates with said light control device via said first communication interface, and
wherein said light control device connects with said first communication network via said second communication interface.

2. The light control device according to claim 1, wherein the first communication network is at least one of a WLAN, the internet, a WiFi or a LiFi.

3. The light control device according to claim 1, wherein the first communication network is at least one of cellular, NB-IoT, LoRa, Sigfox, Weightless-P or other similar wireless technology.

4. The light control device according to claim 1, wherein the communication module is configured to communicate with the electrical device via said first communication interface by using a communication based on Bluetooth, BLE, Zigbee, Z-Wave, 6LowPAN, RFID or any other similar wireless technology.

5. The light control device according to claim 2, wherein the communication module is configured to communicate with the electrical device via said first communication interface by using a communication based on Bluetooth, BLE, Zigbee, Z-Wave, 6LowPAN, RFID or any other similar wireless technology.

6. The light control device according to claim 3, wherein the communication module is configured to communicate with the electrical device via said first communication interface by using a communication based on Bluetooth, BLE, Zigbee, Z-Wave, 6LowPAN, RFID or any other similar wireless technology.

7. The light control device according to claim 1, further comprising a light control module configured to control at least one light source in response to a message received by the communication module via the first communication network.

8. The light control device according to claim 2, further comprising a light control module configured to control at least one light source in response to a message received by the communication module via the first communication network.

9. The light control device according to claim 3, further comprising a light control module configured to control at least one light source in response to a message received by the communication module via the first communication network.

10. The light control device according to claim 4, further comprising a light control module configured to control at least one light source in response to a message received by the communication module via the first communication network.

11. The light control device according to claim 1, adapted to understand voice commands.

12. The light control device according to claim 7, adapted to understand voice commands.

13. The light control device according to claim 2, adapted to understand voice commands.

14. The light control device according to claim 3, adapted to understand voice commands.

15. The light control device according to claim 4, adapted to understand voice commands.

16. The light control device according to claim 11, further comprising:
a microphone configured to capture voice commands; and
a speaker configured to one of reply or play music, based on the captured voice commands.

17. (canceled)

18. A light control device associated with a light source, the light control device comprising:
a communications network, wherein the communications network is at least one of a WLAN, WiFi, LiFi, cellular, NB-IoT, LoRa, Sigfox, Weightless-P and other similar wireless technology,
a housing;
a communication module configured to enable communication for an electrical device over the communication network,
wherein said communication module includes a first communication interface and a second communication interface,
wherein said electrical device communicates with said light control device using at least one of Bluetooth, BLE, Zigbee, Z-Wave, 6LowPAN, RFID or other similar wireless technology,
wherein said light control device connects with said first communication network via said second communication interface, and
wherein said communication module is housed in said housing;
at least one light fixture;
at least one of a microphone or speaker;
a light control module; and
a light control module configured to control at least one light source in response to a message received by the communication module via the communication network.

19. (canceled)

24. (canceled)
